(19) United States
(12) Patent Application Publication
(10) Pub. No.: US 2008/0101903 A1
(43) Pub. Date: May 1, 2008

(54) TRANSPORT SYSTEM AND METHOD

(75) Inventors: John A. Waner, Kirkland, WA (US); Michael Lee Rumer, Kent, WA (US); Max Pau, Sammamish, WA (US); Kai-Chi Lam, Bellevue, WA (US)

Correspondence Address: DAVIS WRIGHT TREMAINE, LLP/Seattle, 1201 Third Avenue, Suite 2200, SEATTLE, WA, 98101-3045, US

(73) Assignee: INTERNATIONAL RETAIL SERVICES GROUP, LLC, Woodinville, WA (US)

(21) Appl. No.: 11/929,649

(22) Filed: Oct. 30, 2007

Related U.S. Application Data
(60) Provisional application No. 60/863,537, filed on Oct. 30, 2006.

(51) Int. Cl. B62B 3/06; A61G 7/08; B66F 5/00

(52) U.S. Cl. 414/495; 180/11; 180/19.2; 414/812

(57) ABSTRACT

As will be discussed in greater detail herein, a transport system is used to move wheeled structures, such as beds. A wheeled bed will be used as the depicted implementation, but other wheeled structures can also be moved by the transport system. The compact design of the transport system allows the transport system when coupled with a bed to be maneuvered through space restricted areas such as elevators.

### CROSS REFERENCE TO RELATED APPLICATION

This application claims priority benefit of provisional application Ser. No. 60/863,537 filed Oct. 30, 2006, the content of which is incorporated in its entirety.

### BACKGROUND OF THE INVENTION

1. Field of the Invention

The present invention is directed generally to transport systems for wheeled structures.

2. Description of the Related Art

Wheeled structures include shelving units and beds, such as hospital type beds. The wheeled structures have wheels coupled to leg bottoms to give a degree of mobility. Some of the wheeled structures can be quite heavy to be moved by humans, particularly if the wheeled structures are carrying additional weight such as with a hospital bed carrying a patient or a shelving unit holding stored items.

### BRIEF DESCRIPTION OF THE SEVERAL VIEWS OF THE DRAWING(S)

FIG. 1 is a perspective view of a depicted version of a transport system with concave blade members in the down position.

FIG. 2 is a side-elevational view of the transport system of FIG. 1 with concave blade members in the down position.

FIG. 3 is a top plan view of the transport system of FIG. 1 with concave blade members in the down position.

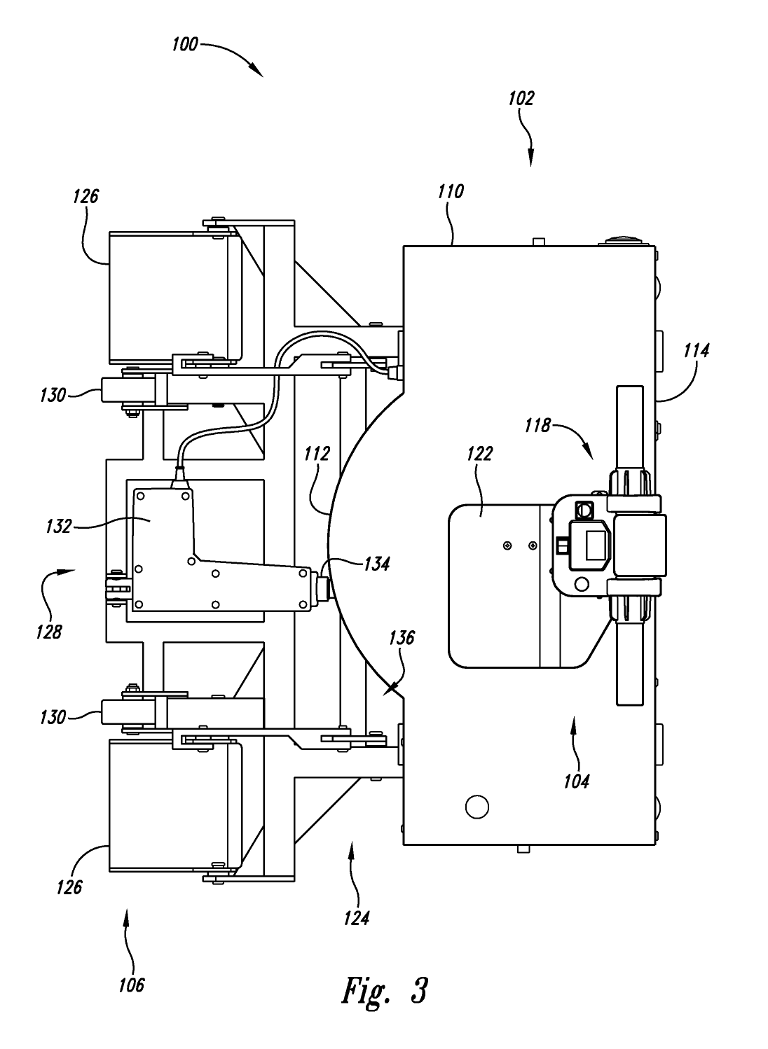

FIG. 4 is a fragmentary perspective view of the transport system of FIG. 1 showing detail of the engagement unit with concave blade members in the down position.

FIG. 5 is a perspective view of the transport system of FIG. 1 with concave blade members in the up position.

FIG. 6 is a side-elevational view of the transport system of FIG. 1 with concave blade members in the up position.

FIG. 7 is a top plan view of the transport system of FIG. 1 with concave blade members in the up position.

FIG. 8 is a fragmentary perspective view of the transport system of FIG. 1 showing detail of the engagement unit with concave blade members in the up position.

FIG. 9 is a side-elevational view of the transport system with the concave blade members in the down position to receive wheels of a bed for engagement with the transport system.

FIG. 10 is a side-elevational view of the transport system with concave blade members in the up position engaging wheels of the bed.

FIG. 11 is a side-elevational view of the transport system engaged with the bed of FIG. 10 showing clearance with a standard elevator.

FIG. 12 is a fragmentary perspective view of the control handle of the transport system of FIG. 1.

FIG. 13 is a perspective view of an alternative implementation of the transport system with the engagement unit being retractable and shown in a retracted position.

FIG. 14 is a side elevational view of the alternative implementation of FIG. 13.

FIG. 15 is a top plan view of the alternative implementation of FIG. 13.

FIG. 16 is a perspective view of the alternative implementation of FIG. 13 with engagement unit in an extended position and the concave blade members in a down position.

FIG. 17 is a side elevation view of the alternative implementation of FIG. 16.

FIG. 18 is a top plan view of the alternative implementation of FIG. 16.

FIG. 19 is a perspective view of the alternative implementation with the wheel engagement unit in an extended position and the concave blade members in an up position.

FIG. 20 is a side elevational view of the alternative implementation of FIG. 16 shown being positioned to engage a wheeled structure.

FIG. 21 is a side elevational view of the alternative implementation of FIG. 19 shown engaged with the wheeled structure of FIG. 20.

### DETAILED DESCRIPTION OF THE INVENTION

As will be discussed in greater detail herein, a transport system is used to move wheeled structures, such as beds and shelving units. A wheeled bed is depicted in a first implementation and a shelving unit in an alternative implementation, but other wheeled structures can also be moved by the transport system. The compact design of the first implementation allows the transport system when coupled with a bed to be maneuvered through space restricted areas such as elevators.

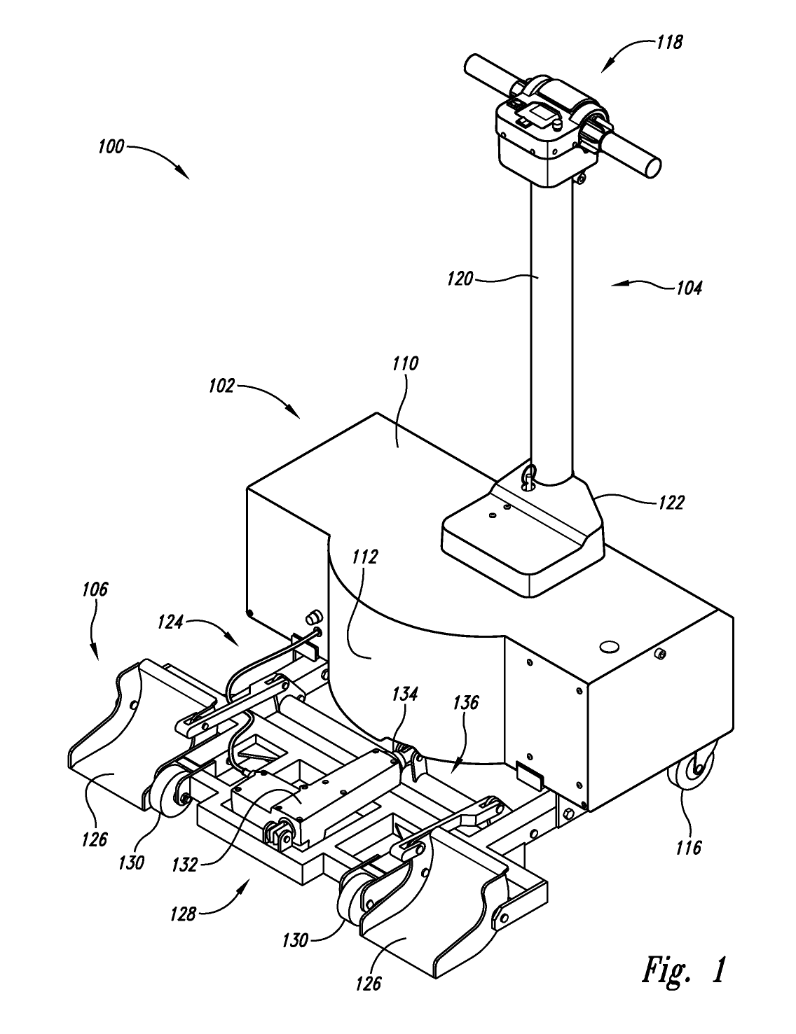

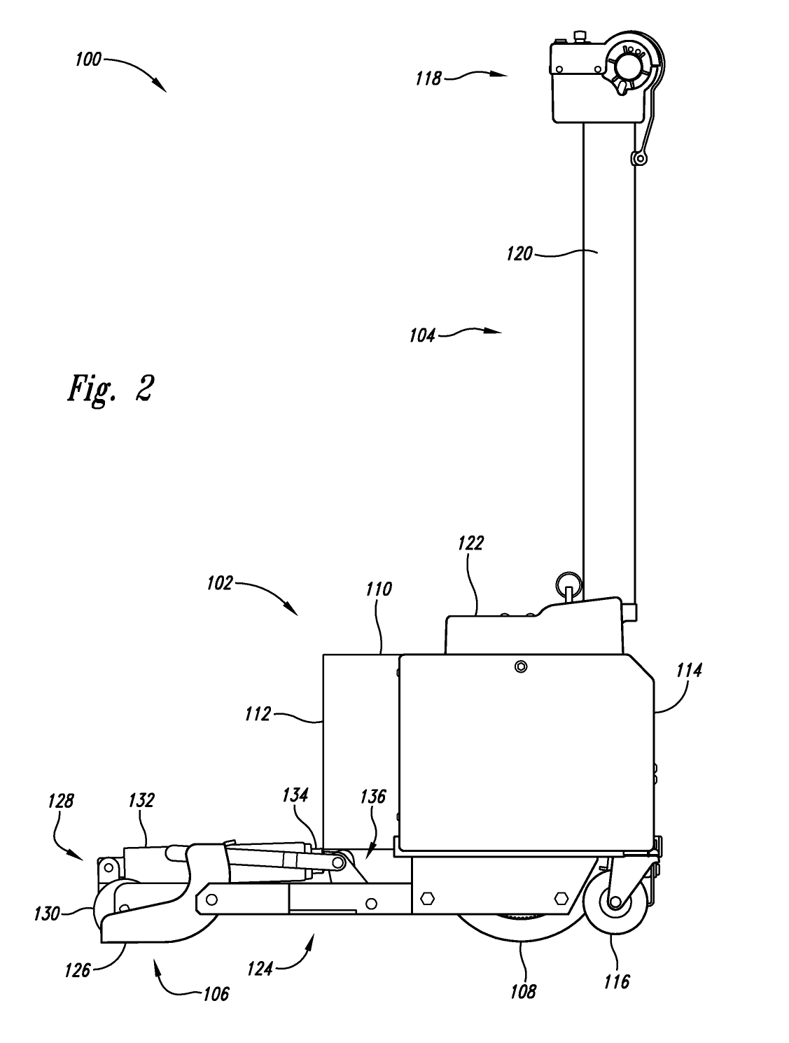

As shown in FIG. 1, an exemplary first implementation of a transport system 100 includes a drive unit 102, a steering unit 104, and an engagement unit 106. The drive unit 102 includes a source of motive power such as a motor (not shown) and at least one drive wheel 108 (shown in FIG. 2) coupled to the motor to provide motive force to the transport system through frictional engagement with a floor surface. The drive unit 102 further includes a housing 110 with a forward end 112 and an aft end 114 that encloses a power source, such as an electric motor, that supplies motive force to the drive wheel 108 to impart motion to the transport system 100. A pair of safety wheels 116 is affixed to the aft end 114 to help prevent the transport system 100 from tipping over.

The steering unit 104 includes a handle portion 118, a column 120, and a mount 122 that couples the steering unit to the housing 110 of the drive unit 102. The handle portion 118 includes controls discussed further below to provide guidance input to the drive unit 102 including speed control of the transport system 100. The steering unit 104 is pivotally coupled to the drive unit 102 through the mount 122 to allow for directional control of the drive wheel 108 with consequential directional control of the transport system 100.

The engagement unit 106 is coupled to the drive unit 102 through a fixed frame portion 124 of the engagement unit. The engagement unit 106 further includes a pair of retractable concave blade members 126 pivotally coupled to the fixed frame portion 124. The fixed frame portion 124 extends away from the drive unit 102 to include a forward end 128 with a pair of support wheels 130 coupled thereto each adjacent a different one of the concave blade members 126. During operation, the transport system 100 typically rests upon the drive wheel 108 and the two support wheels 130 while the two safety wheels 116 remain elevated above floor height.

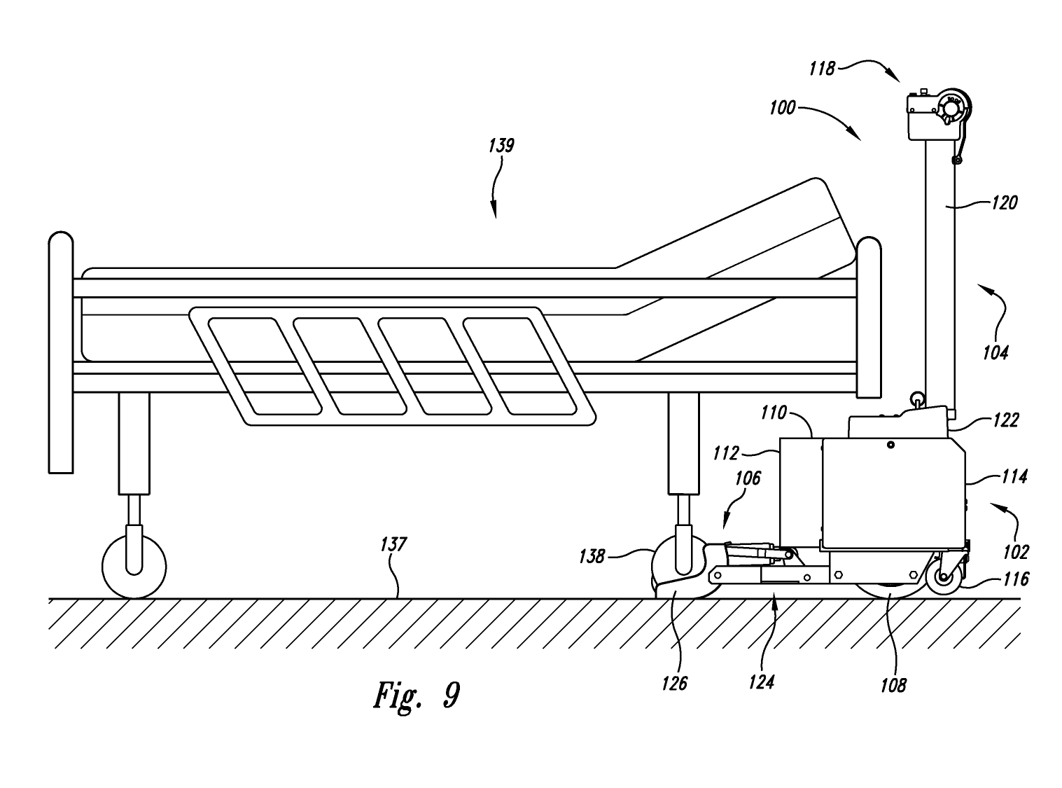

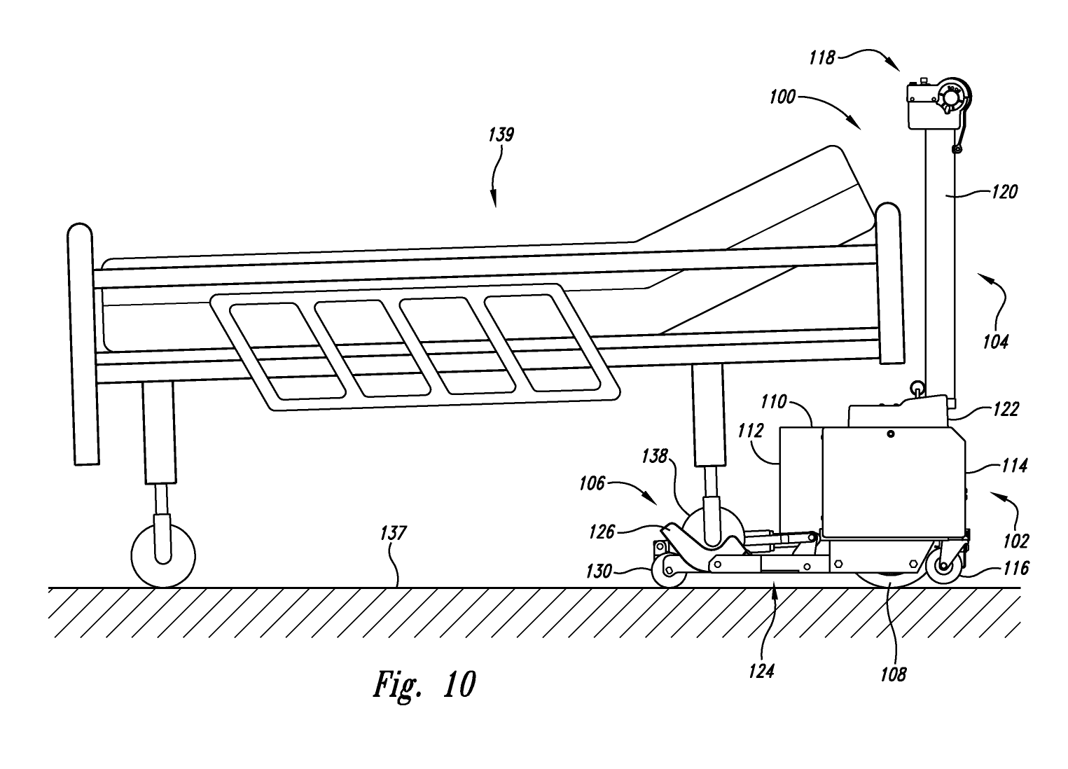

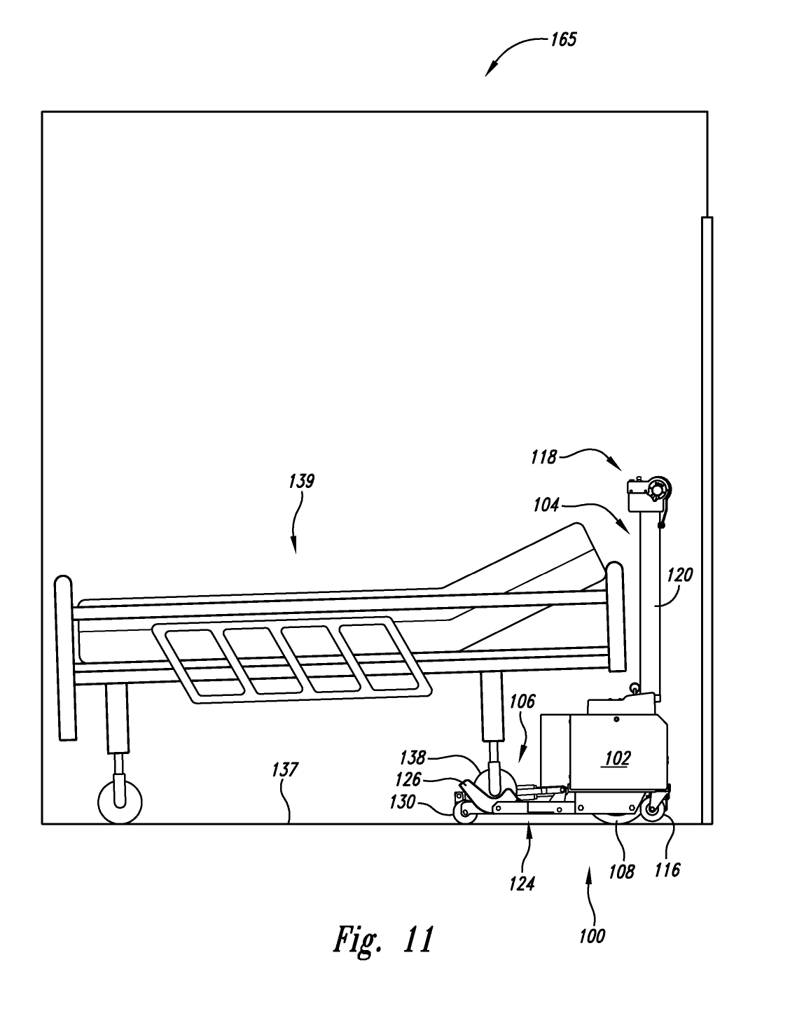

As part of the engagement unit 106, an actuator 132 with a piston 134 (some implementations use other devices such as worm gears) is coupled through linkages 136 to the concave blade members 126 so that when the piston is retracted, the concave blade members are down in a receiving position with the leading edge 126a of the concave blade member 126 adjacent a floor surface 137 as shown in FIG. 9. When the piston is extended, the concave blade members 126 are up in an engaged position with the leading edge 126a of the concave blade member 126 above the floor surface 137 as shown in FIGS. 10-11. Each of the concave blade members 126 are shaped somewhat like a bucket seat with a leading edge 126a of a front portion 126b curving to a mid-portion 126c further curving to a rear portion 126d.

When each of the concave blade members 126 is in the down receiving position, the front portion 126b is substantially horizontal and flush with the floor surface 137 1 to receive a wheel 138 of a bed 139 as shown in FIG. 9 with the mid-portion 126c being in a semi-vertical position and the rear portion 126d being primarily in a vertical position to serve as a backstop in receiving the wheel. As shown in FIG. 10, when each of the concave blade members 126 is in the up engaging position, the curvature of the mid-portion 126c supports the wheel 138 and the weight of the bed 139 and the front portion 126b and the rear portion 126d are in a semi-vertical position acting as stops to further retain the wheel of the bed.

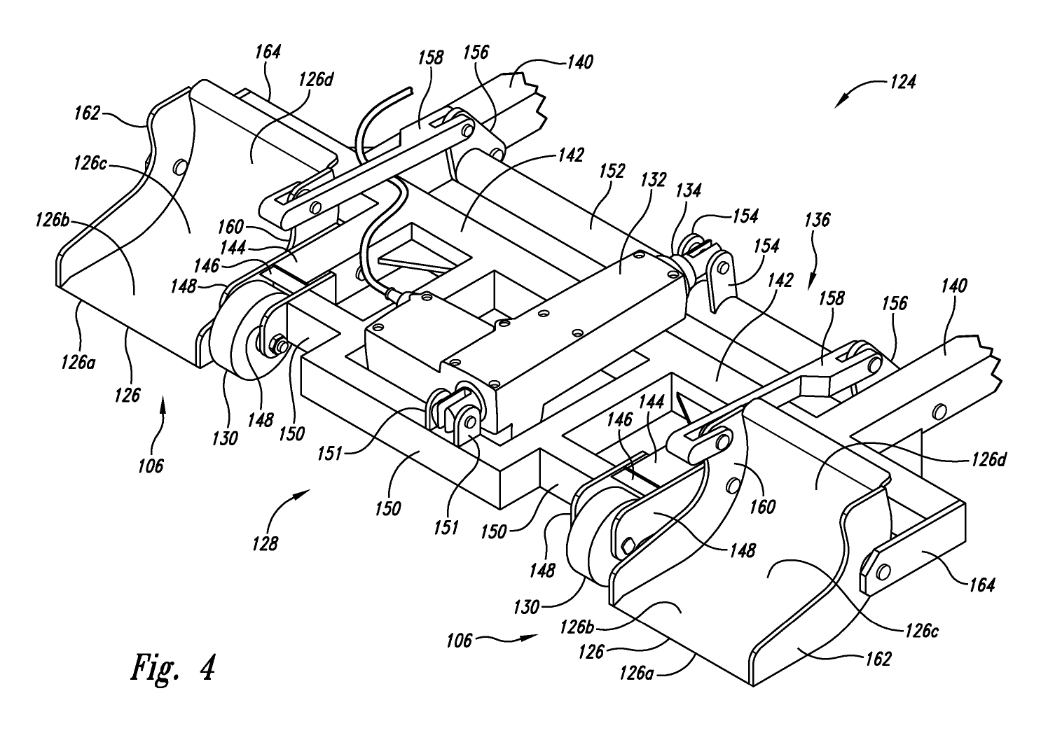

As better shown in FIG. 4, the fixed frame portion 124 of the engagement unit 106 includes two rear elongated support members 140 extending from the drive unit 102 with a rear cross member 142 extending therebetween. Extending from the rear cross member 142 are two forward elongated support members 144 each having ends 146 with one of the two support wheels 130 attached with brackets 148 thereto. A forward cross member 150 extends between the two elongated support members 144. The actuator 132 is pivotally coupled to the forward cross member 150 through a bracket 151.

A cross linkage member 152 extends between the two rear elongated support members 140 and is rotatably coupled thereto. The piston 134 is hingedly coupled to a lever arm 154, which is affixed to the periphery of the cross linkage member 152 to impart torque and consequential rotation of the cross linkage member about the longitudinal axis of the cross linkage member. Each of two brackets 156 are located on either end of the cross linkage member 152 and are each pivotally coupled to a different elongated linkage member 158. Each of the two concave blade members 126 are integrated with a different inner side 160 that is pivotally coupled to a different one of the two elongated linkage members 158. Each of the inner sides 160 is also pivotally coupled to a different one of the two forward elongated support members 144 that is adjacent to the inner side.

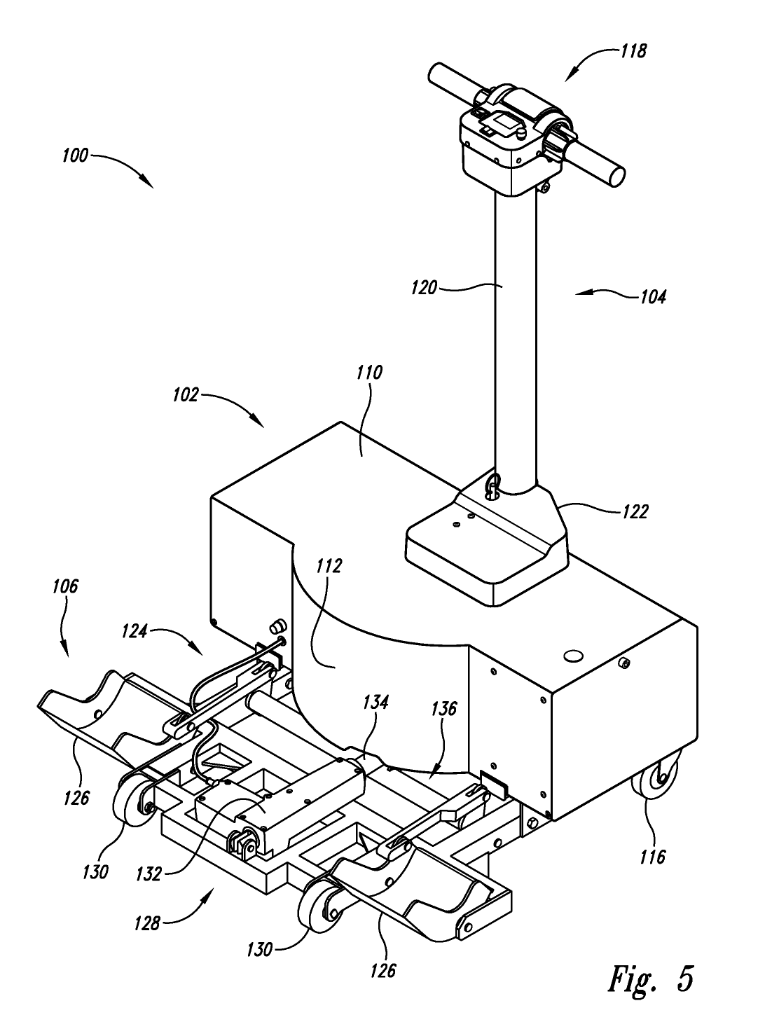

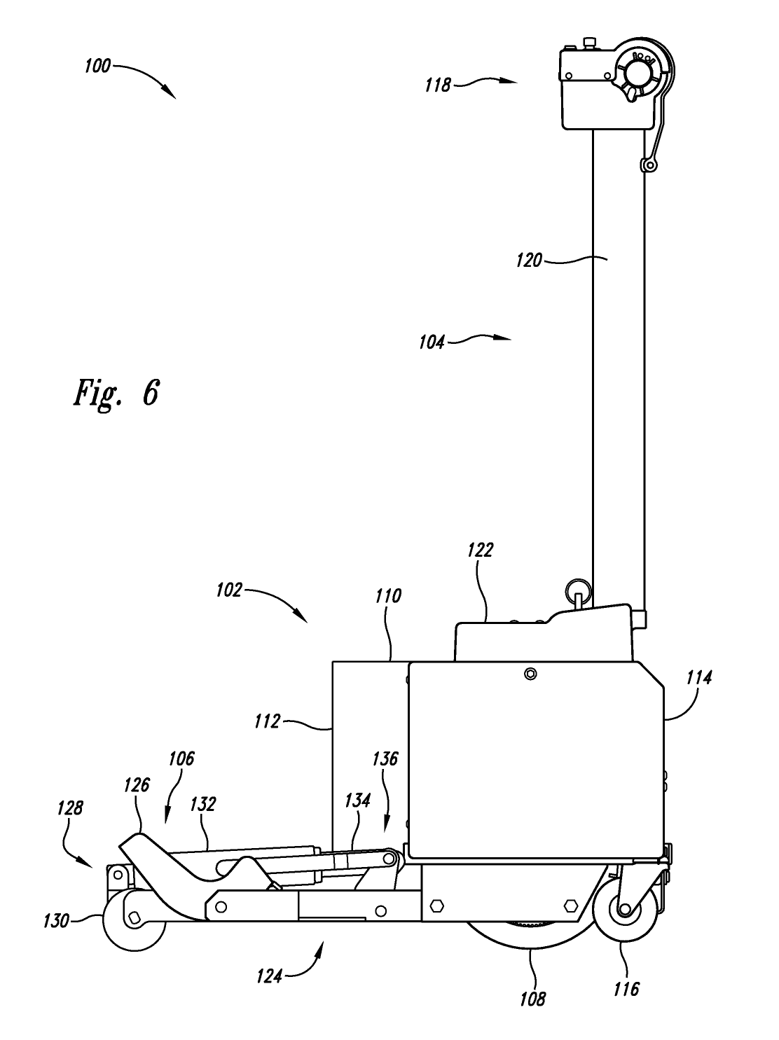

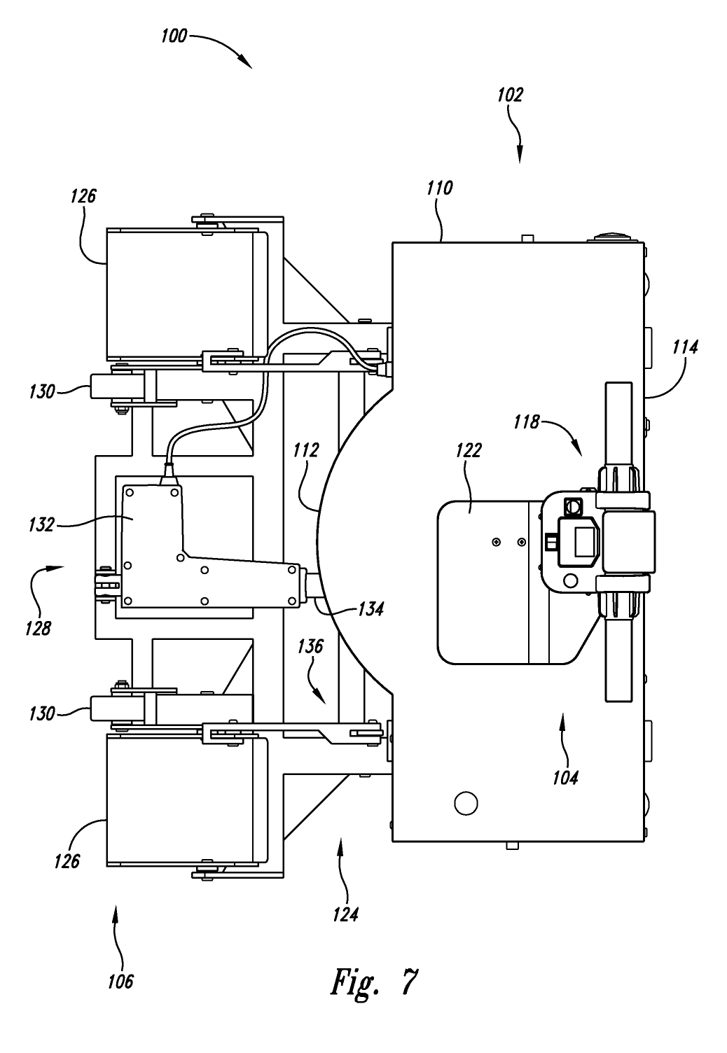

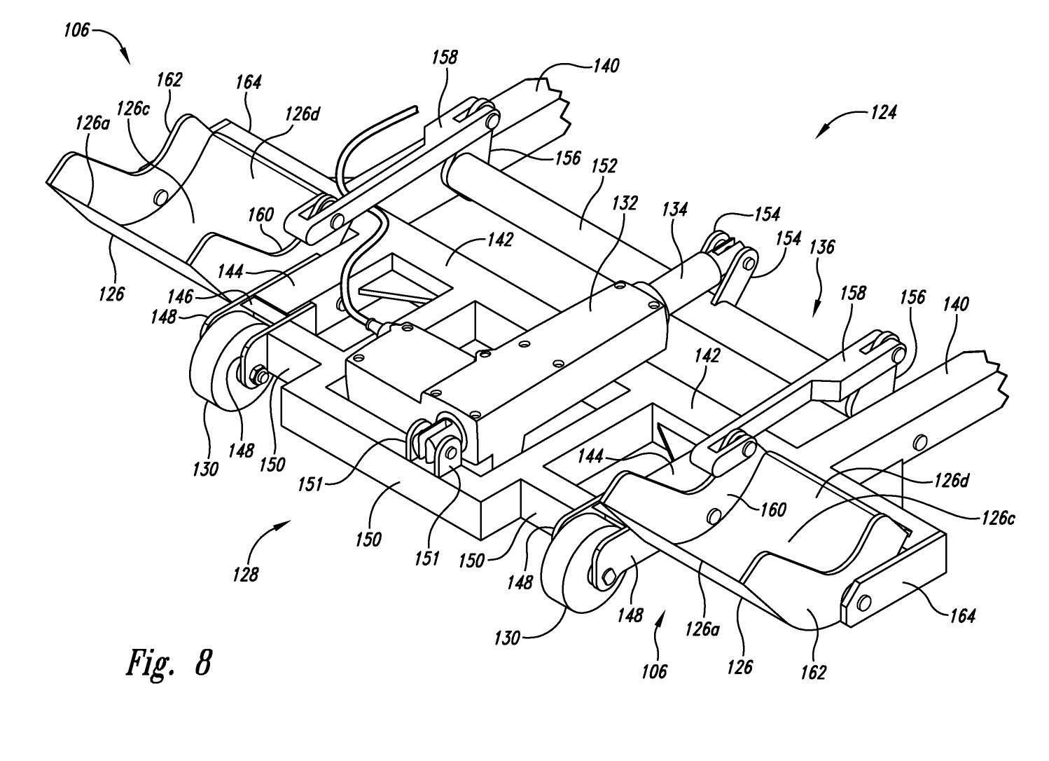

Each of the two concave blade members 126 are integrated with a different outer side 162 that is pivotally coupled to a different bracing member 164 extending from a different one of the two rear elongated support members 140. FIGS. 5-8 further show the first implementation with the concave blade members 126 in an up position.

Dimensioning of the drive unit 102 and the engagement unit 106 including the rear elongated support members 140 and the forward elongated support members 144 can result in a relatively short combined length of the bed 139 and the transport system 100 when the transport system is engaged with the bed to allow for positioning within a standard elevator 165 as shown in FIG. 11.

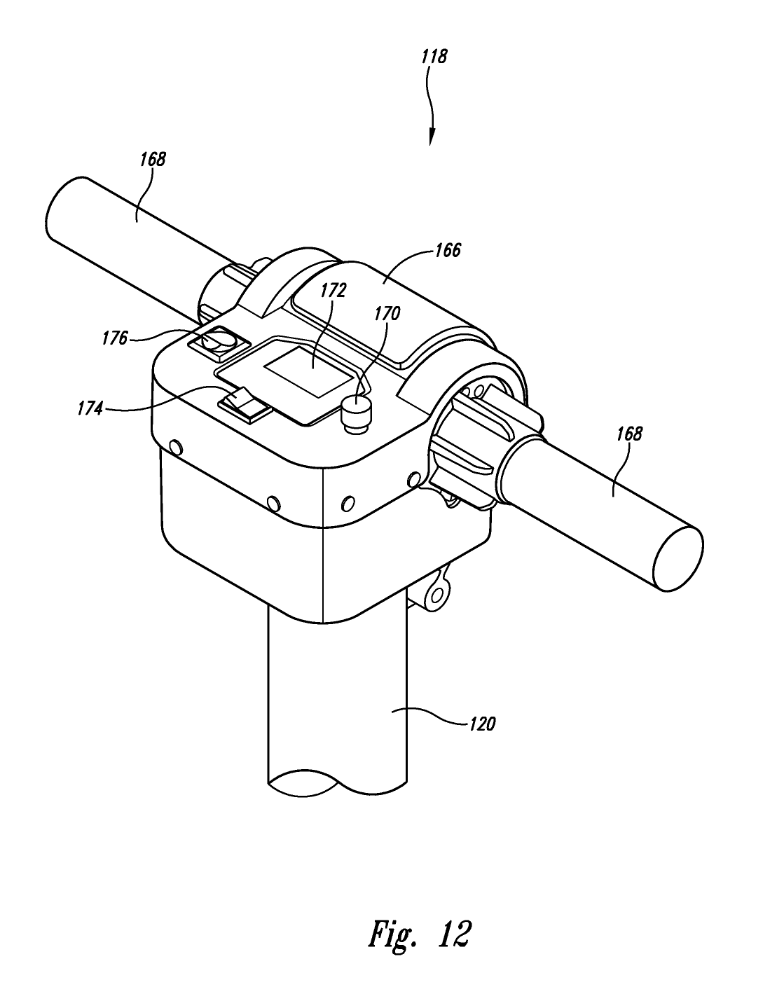

The handle portion 118 of the steering unit 104 is shown in FIG. 12 as including an emergency stop button 166, rotatable handles 168 for forward and reverse directional control, a fuse access 170, a display 172, a power switch 174, and a concave blade member position control switch 176.

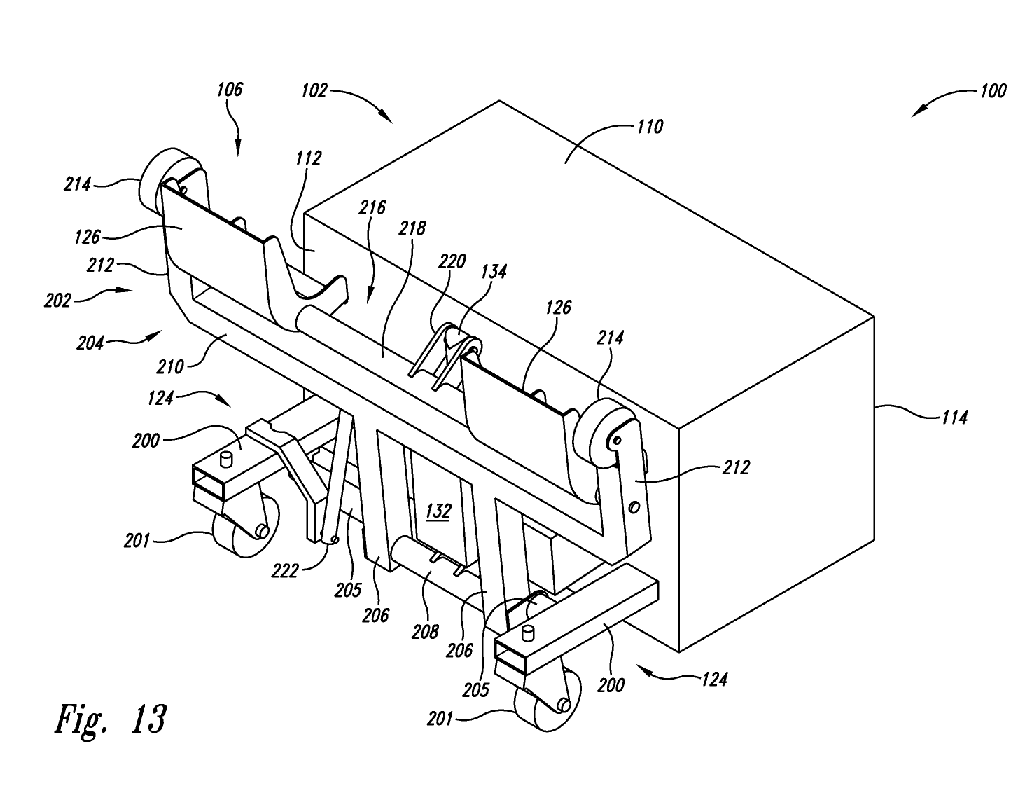

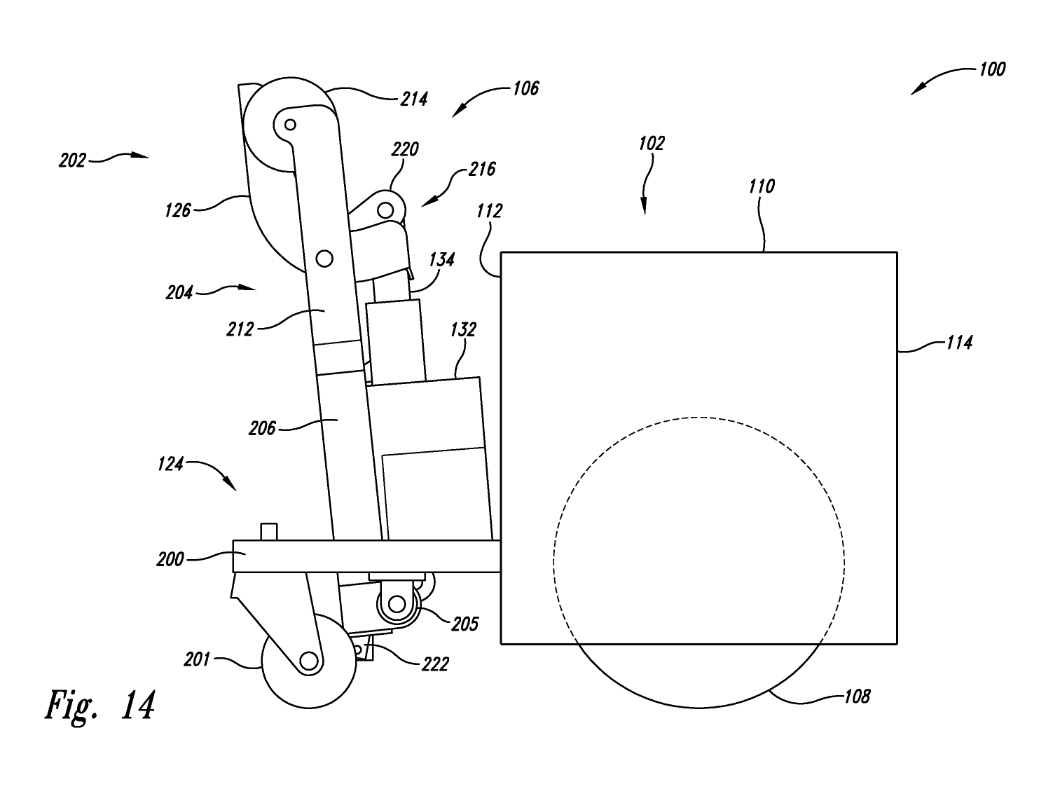

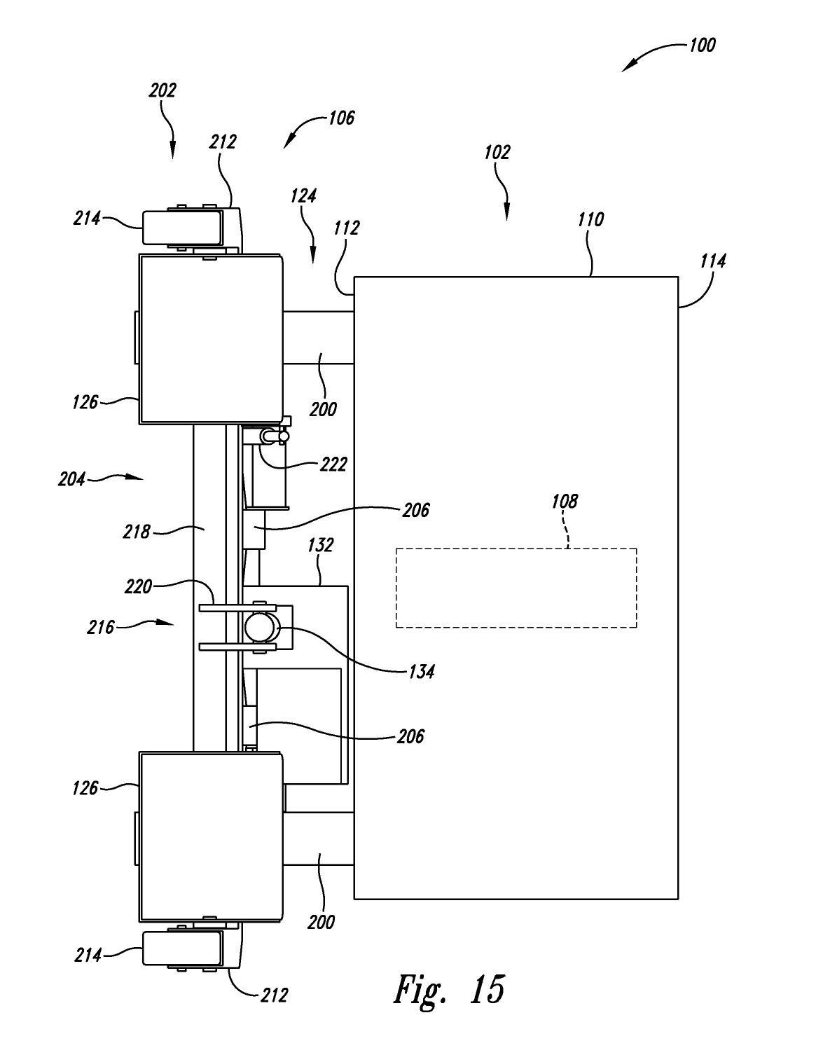

An alternative implementation of the transport system 100 with the engagement unit 106 being retractable is shown in FIGS. 13-15 with the engagement unit being in a retracted position. The engagement unit 106 of the alternative implementation includes two fixed frame portions 200 each supported by wheels 201 and extending from the drive housing 114. The engagement unit 106 further includes a retractable portion 202 having a frame portion 204 that is pivotally coupled to the fixed frame portions 200 through two pivot members 205. The frame portion 204 has two rearwardly extending members 206, each having a different one of the pivot members 205 extending therefrom. As depicted, the pivot members 205 are pivotally coupled to the fixed frame portion 200, but in other implementations, the pivot members can be pivotally coupled to the rearwardly extending members 206.

For additional support the rearwardly extending members 206 have a rear cross member 208 extending therebetween. The frame portion 204 further includes a forward cross member 210 from which the rearwardly extending members 206 extend and from which two forwardly extending members 212 extend on either end of the forward cross member. A wheel 214 is attached to each of the forwardly extending members 212 for support. A blade unit 216 of the retractable portion 202 includes the two concave blade members 126 with a cross member 218 extending therebetween. Each of the concave blade members 126 is pivotally coupled to a different one of the forwardly extending embers 212. Extending from the cross member 218 is a lever arm 220, which is pivotally coupled to the piston 134 of the actuator 132 to cause the cross member and consequently the concave blade members 126 to pivot. A support strut 222 is depicted as coupled to one of the fixed frame portions 200 and the retractable portion 202 to assist when the retractable portion is to be lifted from the extended to the retracted position.

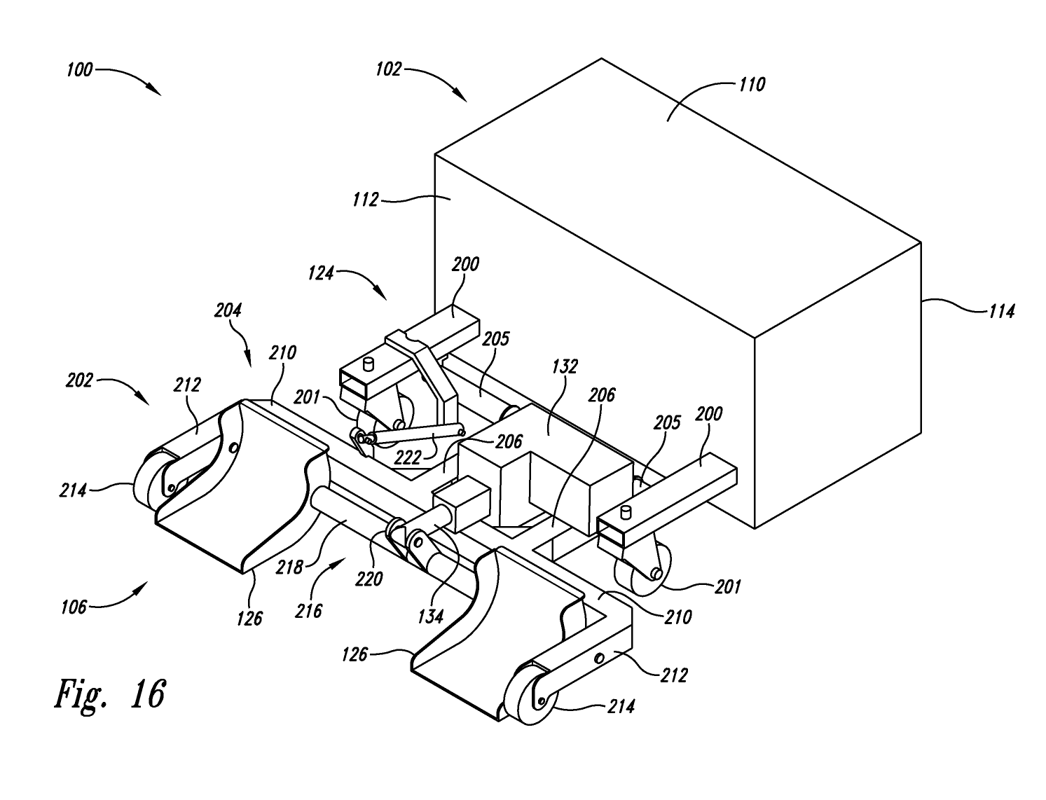

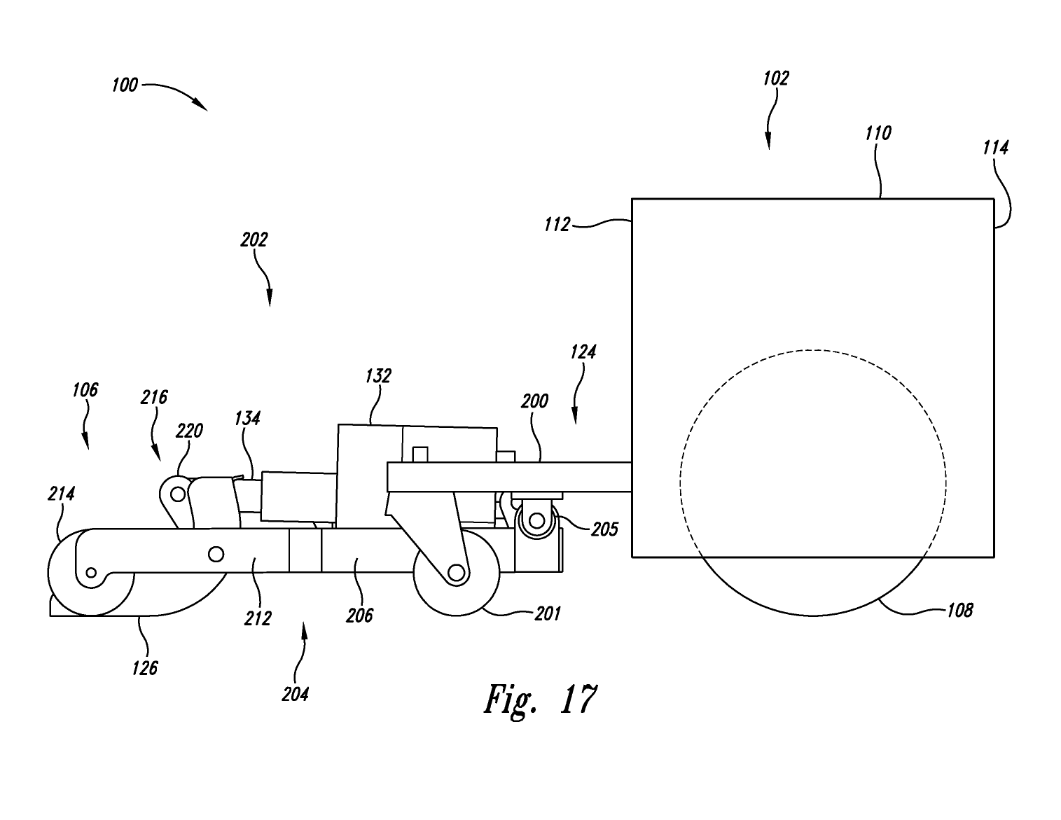

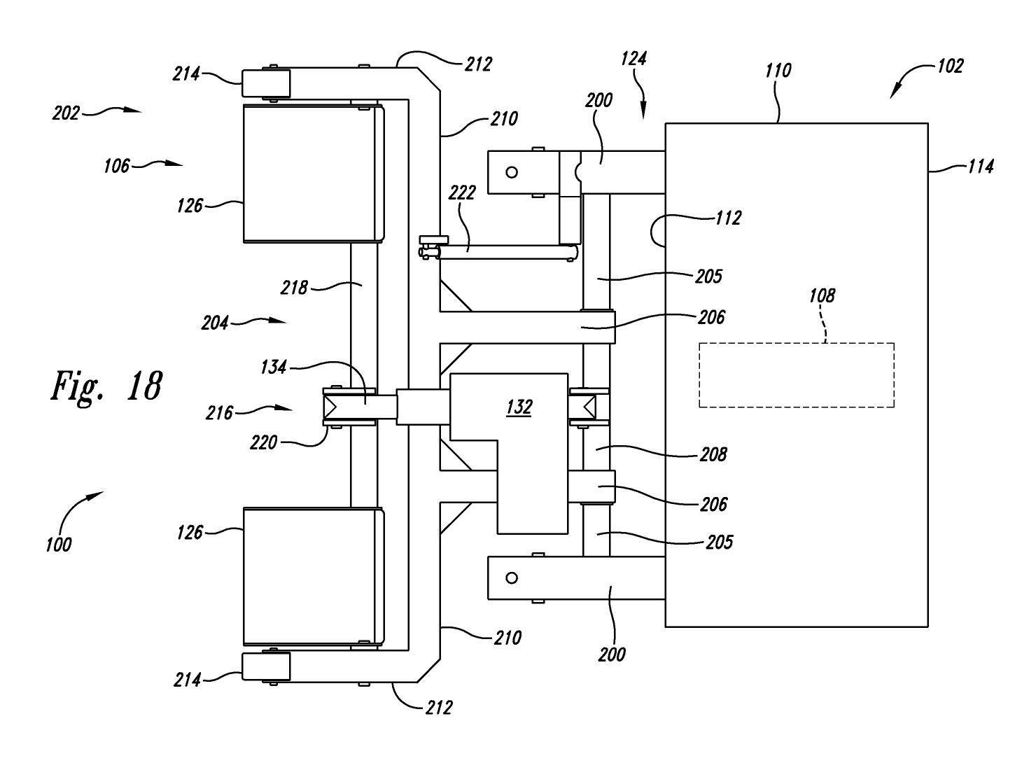

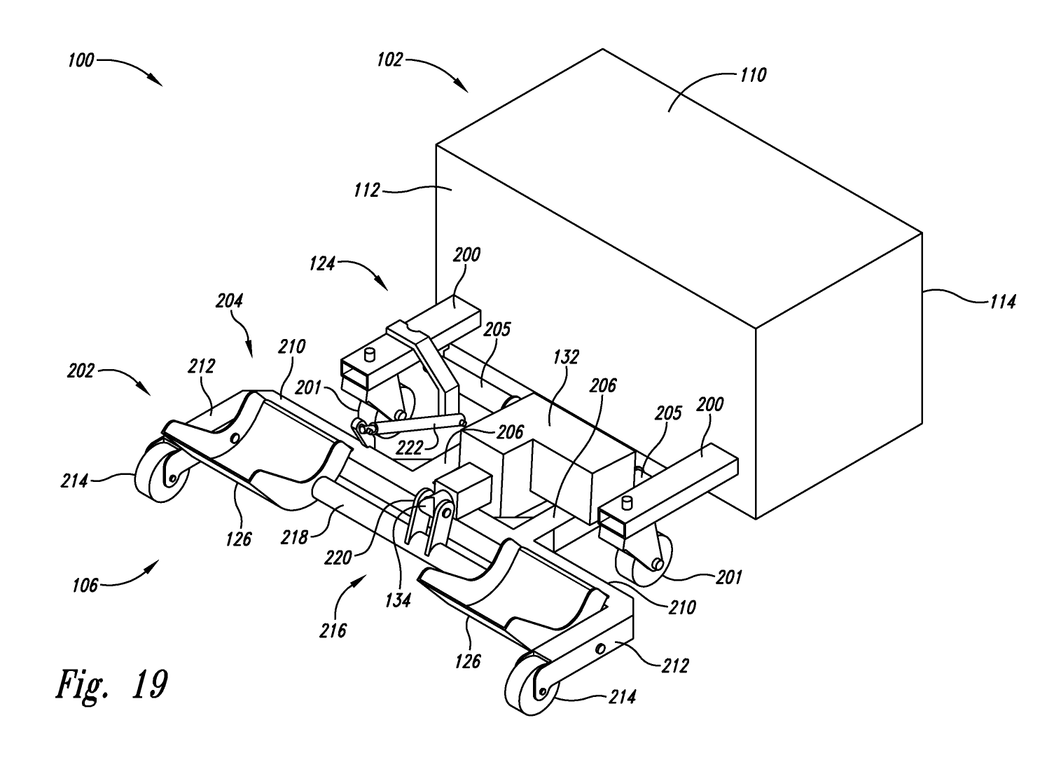

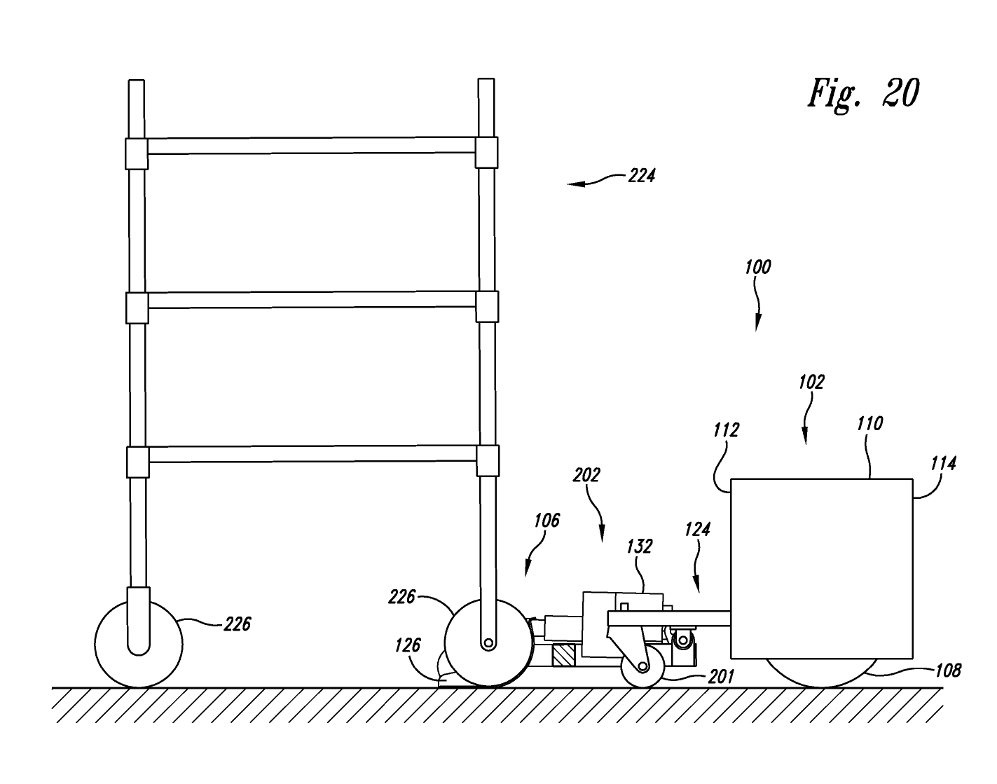

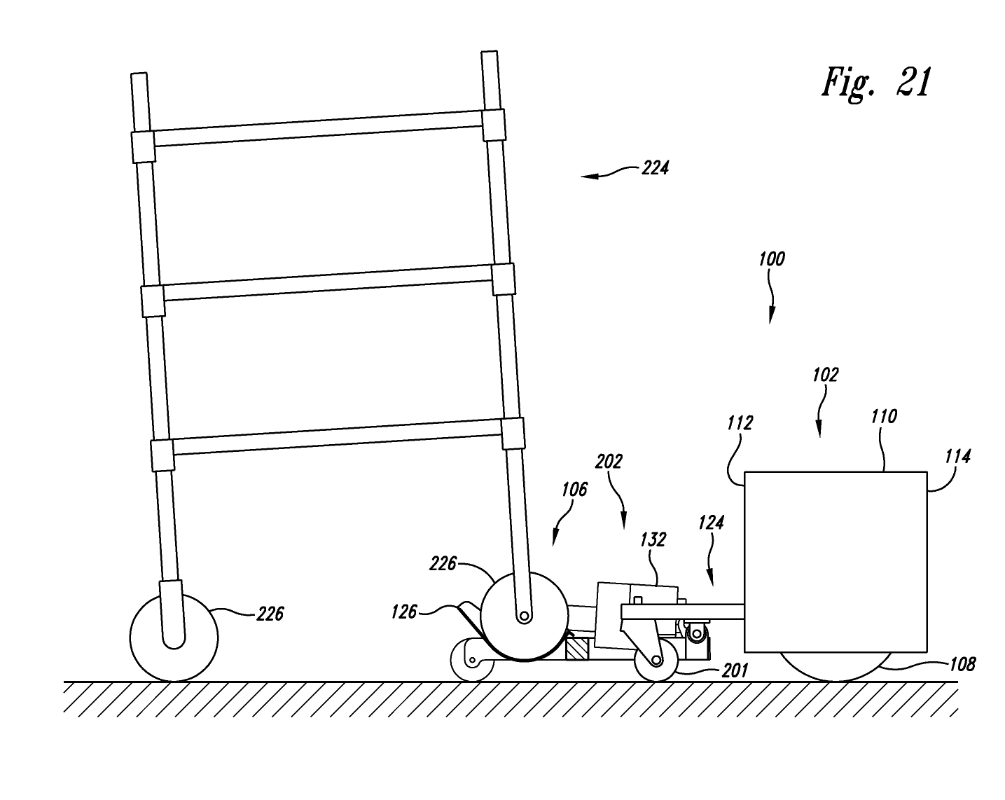

The alternative implementation is depicted in FIGS. 16-18 with the engagement unit 106 in an extended position and the concave blade members 126 in a down position. In FIG. 19 the alternative implementation has the wheel engagement portion in an extended position and the concave blade members in an up position. In FIG. 20 the alternative implementation is shown being positioned to engage a wheeled structure 224, such as a shelving unit with the engagement unit 106 in an extended position and the concave blade members 126 in a down position to engage wheels 226 of the shelving unit. In FIG. 21 the alternative implementation is shown engaged with the wheeled structure 224 with the engagement unit 106 in an extended position and the concave blade members 126 in an up position.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is

1. A system comprising:
a first concave blade member having a leading edge, the first concave blade member pivotally coupled about a horizontal axis to rotate between a first position and a second position, the leading edge having a first elevation when the first concave blade member is in the first position and a second elevation when the first concave blade member is in the second position, the first elevation being lower than the second elevation;
a second concave blade member having a leading edge, the second concave blade member pivotally coupled about a horizontal axis to rotate between a first position and a second position, the leading edge having a first elevation when the second concave blade member is in the first position and a second elevation when the second concave blade member is in the second position, the first elevation being lower than the second elevation;
a fixed frame portion; and
a drive wheel configured to receive motive force to impart motion to the system, the drive wheel coupled through the fixed frame portion with the first concave blade member and the second concave blade member.

2. The system of claim 1 including a housing to enclose the drive wheel and the fixed frame portion includes a first elongated member and a second elongated member, the first concave blade member being rotatably coupled to the first elongated member and the second concave blade member being rotatably coupled to the second elongated member.

3. The system of claim 1 including an actuator and linkage members, the actuator coupled through the linkage members to rotate the first concave blade member between the first position and the second position and to rotate the second concave blade member between the first position and the second position.

4. The system of claim 3 wherein the actuator has a piston that extends outward to move the first concave blade member from the first position to the second position and to move the second concave blade member from the first position to the second position.

5. The system of claim 1 further including a first support wheel rotatably coupled to the fixed frame portion substantially adjacent the first concave blade member and the second support wheel rotatably coupled to the fixed frame portion substantially adjacent the second concave blade member.

6. The system of claim 1 wherein the first concave blade member and the second concave blade member are spaced apart to each receive a wheel of a bed.

7. The system of claim 1 wherein the first concave blade member and the second concave blade member are each sized to receive a wheel of a bed.

8. The system of claim 1 wherein the leading edge of the first concave blade member is adjacent a floor surface in the first elevation.

9. The system of claim 1 further including a steering unit coupled to the drive wheel wherein motion imparted by the drive wheel to the system is controlled by a steering unit.

10. The system of claim 1 including a housing to enclose the drive wheel wherein the fixed frame portion and the housing are sized and positioned to allow for a substantial entirety of the fixed frame portion and a substantial portion of the housing to be located underneath a bed having first and second wheels when the first and second concave blade members are in the respective second positions engaged with the first and second wheels, respectively.

11. A system comprising:
a drive unit including a drive wheel configured to receive motive force to impart motion to the system;
a first elongated member extending from the drive unit;
a second elongated member extending from the drive unit;
a cross member extending between a first end bracket and a second end bracket, the first end bracket being pivotally coupled to the first elongated member and the second end bracket being pivotally coupled to the second elongated member for rotation of the cross member about a longitudinal axis extending between the first elongated member and the second elongated member,
an actuator coupled to the cross member to rotate the cross member about the longitudinal axis between a first rotational position and a second rotational position;
a first concave blade member having a leading edge, the first concave blade member pivotally coupled about a horizontal axis to rotate between a leading edge down position and a leading edge up position, the first concave blade member coupled to the cross member through a first linkage member to move the first concave blade member between the leading edge down position and the leading edge up position when the cross member rotates between the first rotational position and the second rotational position;
a second concave blade member having a leading edge, the second concave blade member pivotally coupled about a horizontal axis to rotate between a leading edge down position and a leading edge up position, the first concave blade member coupled to the cross member through a first linkage member to move the first concave blade member between the leading edge down position and the leading edge up position when the cross member rotates between the first rotational position and the second rotational position; and
a first support wheel; and
a second support wheel, the first support wheel located closer to the first concave blade member than the second support wheel, the second support wheel located closer to the second concave blade member than the first support wheel.

12. The system of claim 11 wherein the drive unit includes a housing to enclose the drive wheel and the first elongated member and the second elongated member extend from the housing.

13. The system of claim 11 wherein the actuator has a piston that extends outward to move the first concave blade member from the leading edge down position to the leading edge up position and to move the second concave blade member from the leading edge down position to the leading edge up position.

14. The system of claim 11 wherein the first support wheel is rotatably coupled to the first elongated support member being substantially adjacent the first concave blade member and the second support wheel is rotatably coupled to the second elongated support member being substantially adjacent the second concave blade member.

15. The system of claim 11 wherein the first concave blade member and the second concave blade member are spaced apart to each receive a wheel of a bed when in the respective leading edge down positions.

16. The system of claim 11 wherein the first concave blade member and the second concave blade member are each sized to receive a wheel of a bed.

17. The system of claim 11 wherein the leading edge of the first concave blade member is adjacent a floor surface in the leading edge down position.

18. The system of claim 11 further including a steering unit coupled to the drive wheel wherein motion imparted by the drive wheel to the system is controlled by a steering unit.

19. The system of claim 11 including a housing to enclose the drive wheel wherein the first elongated member, the second elongated member, and the housing are sized and positioned to allow for a substantial entirety of the first elongated member and the second elongated member and a substantial portion of the housing to be located underneath a bed having first and second wheels when the first and second concave blade members are in the respective leading edge up positions engaged with the first and second wheels, respectively.

20. A method comprising:
moving a first wheel supporting a structure onto a first concave blade member having a leading edge, the first concave blade member pivotally coupled about a horizontal axis to rotate between a first position and a second position, the leading edge having a first elevation when the first concave blade member is in the first position and a second elevation when the first concave blade member is in the second position, the first elevation being lower than the second elevation, the first concave blade member being in the first position;
moving a second wheel supporting a structure onto a second concave blade member having a leading edge, the second concave blade member pivotally coupled about a horizontal axis to rotate between a first position and a second position, the leading edge having a first elevation when the second concave blade member is in the first position and a second elevation when the second concave blade member is in the second position, the first elevation being lower than the second elevation, the second concave blade position being in the first position;
rotating the first concave blade member from the first position to the second position to engage the first wheel supporting the structure with the first concave blade member;
rotating the second concave blade member from the first position to the second position to engage the second wheel supporting the structure with the second concave blade member; and
applying a motive force to a drive wheel coupled with the first concave blade member and the second concave blade member to impart motion to the first concave blade member and the second concave blade member and thereby to impart motion to the structure.

21. The method of claim 1 wherein the first wheel and the second wheel support the structure as a bed and the motion imparted to move the structure moves the bed.

22. The method of claim 21 wherein the bed in moved into an elevator.

23. The method of claim 20 wherein rotating the first concave blade member and rotating the second concave blade member is performed through use of an actuator coupled to the first concave blade member and the second concave blade member through linkage members.

24. The method of claim 20 wherein rotating the first concave blade member and rotating the second concave blade member is performed through use of a piston of an actuator that extends outward to rotate the first concave blade member from the first position to the second position and to rotate the second concave blade member from the first position to the second position.

25. A system comprising:
a retractable portion including:
a first concave blade member having a leading edge, the first concave blade member pivotally coupled about a horizontal axis to rotate between a first position and a second position, the leading edge having a first elevation when the first concave blade member is in the first position and a second elevation when the first concave blade member is in the second position, the first elevation being lower than the second elevation; and
a second concave blade member having a leading edge, the second concave blade member pivotally coupled about a horizontal axis to rotate between a first position and a second position, the leading edge having a first elevation when the second concave blade member is in the first position and a second elevation when the second concave blade member is in the second position, the first elevation being lower than the second elevation;
a fixed frame portion, the retractable portion pivotally coupled to the fixed frame portion to move between an extended position and a retracted position; and
a drive wheel configured to receive motive force to impart motion to the system, the drive wheel coupled through the fixed frame portion to the retractable portion.
